(19) United States
(12) Patent Application Publication
(10) Pub. No.: US 2026/0004954 A1
(43) Pub. Date: Jan. 1, 2026

(54) MANUFACTURING APPARATUS FOR ENAMELED COPPER WIRE AND MANUFACTURING METHOD FOR ENAMELED COPPER WIRE

(71) Applicant: Proterial, Ltd., Tokyo (JP)

(72) Inventors: Akira SETOGAWA, Tokyo (JP); Hajime NISHI, Tokyo (JP); Takami USHIWATA, Tokyo (JP); Yuki HONDA, Tokyo (JP); Takumi SATO, Tokyo (JP); Sohei KODAMA, Tokyo (JP)

(21) Appl. No.: 19/251,285

(22) Filed: Jun. 26, 2025

(30) Foreign Application Priority Data
Jun. 27, 2024 (JP) 2024-104016

(51) Int. Cl. H01B 13/06; H01B 13/00

(52) U.S. Cl. CPC H01B 13/065; H01B 13/0003; H01B 13/0016; H01B 13/0036

(57) ABSTRACT

A manufacturing apparatus for an enameled copper wire of the present disclosure includes: a coating material application section configured to apply a coating material to a surface of a conductor in traveling; a baking section configured to bake the conductor to which the coating material has been applied; and a dehumidifying section configured to set an absolute humidity in a space in which the manufacturing apparatus is installed to 18 g/m³ or less.

### CROSS-REFERENCE TO RELATED APPLICATIONS

This application claims the benefit of Japanese Patent Application No. 2024-104016 filed on Jun. 27, 2024 with the Japan Patent Office, the entire disclosures of which are incorporated herein by reference.

### BACKGROUND

The present disclosure relates to a manufacturing apparatus for an enameled copper wire and a manufacturing method for an enameled copper wire.

The enameled copper wire comprises a conductor and an enamel coating. The conductor is mainly made of copper. The enamel coating covers a surface of the conductor. Japanese Unexamined Patent Application Publication No. 2019-3913 describes a manufacturing method for an enameled copper wire. In the manufacturing method for an enameled copper wire, an enamel coating material is applied to the surface of the conductor to form a coating material film. Then, the coating material film is baked to form the enamel coating.

### SUMMARY

Apparently abnormal parts may be generated in the manufactured enameled copper wire. In one aspect of the present disclosure, it is desirable to provide a manufacturing apparatus for an enameled copper wire and a manufacturing method for an enameled copper wire in which generation of apparently abnormal parts can be inhibited.

One aspect of the present disclosure provides a manufacturing apparatus for an enameled copper wire. The manufacturing apparatus includes: a coating material application section configured to apply a coating material to a surface of a conductor in traveling; a baking section configured to bake the conductor to which the coating material has been applied; and a dehumidifying section configured to set an absolute humidity in a space in which the manufacturing apparatus is installed to 18 g/m³ or less. This manufacturing apparatus makes it possible to inhibit generation of apparently abnormal parts in the manufactured enameled copper wire.

Another aspect of the present disclosure provides a manufacturing method for an enameled copper wire. The manufacturing method includes: applying a coating material to a surface of a conductor in traveling; baking the conductor to which the coating material has been applied; and setting an absolute humidity in a space in which the method for manufacturing an enameled copper wire is performed to 18 g/m³ or less. This manufacturing method makes it possible to inhibit generation of apparently abnormal parts in the manufactured enameled copper wire.

### BRIEF DESCRIPTION OF THE DRAWINGS

An example embodiment of the present disclosure will be described hereinafter with reference to the accompanying drawings, in which:

FIG. 1 is an explanatory diagram showing a configuration of a manufacturing apparatus for a flat enameled copper wire;

FIG. 2 is a sectional view showing a cross-sectional shape of a flat copper wire;

FIG. 3 is a sectional view showing a cross-sectional shape of a flat copper drawn wire;

FIG. 4 is a schematic diagram showing a mechanism of generating apparently abnormal parts;

FIG. 5 is a graph showing a relationship between a temperature and a relative humidity in a space and probability in generating apparently abnormal parts;

FIG. 6A is an explanatory diagram showing an apparently abnormal part existing alone;

FIG. 6B is an explanatory diagram showing a continuous abnormal part; and

FIG. 7 is a graph showing a relationship between an absolute humidity in the space and a proportion of products not inhibiting apparently abnormal parts.

### DETAILED DESCRIPTION OF EXEMPLARY EMBODIMENTS

### First Embodiment

### Configuration of Manufacturing Apparatus 1 and Manufacturing Method for Flat Enameled Copper Wire

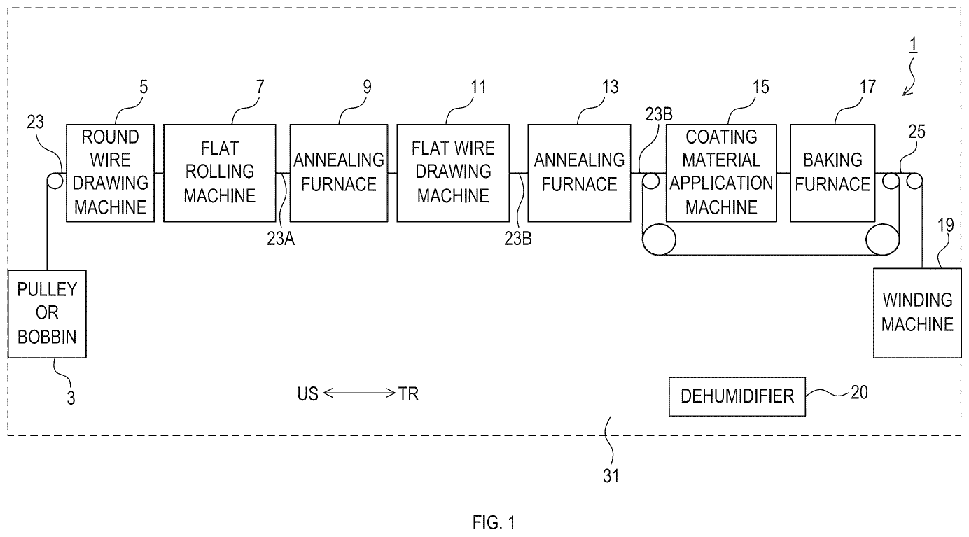

A manufacturing method for a flat enameled copper wire will be described with reference to FIGS. 1 to 3. The manufacturing method for the flat enameled copper wire uses a manufacturing apparatus 1 for a flat enameled copper wire shown in FIG. 1. The manufacturing apparatus 1 for the flat enameled copper wire comprises a pulley or bobbin 3, a round wire drawing machine 5, a flat rolling machine 7, an annealing furnace 9, a flat wire drawing machine 11, an annealing furnace 13, a coating material application machine 15, a baking furnace 17, a wind-up machine 19, and a dehumidifier 20. The dehumidifier 20 corresponds to an example of the dehumidifying section. The coating material application machine 15 corresponds to an example of the coating material application section. The baking furnace 17 corresponds to an example of the baking section. The manufacturing apparatus 1 for the flat enameled copper wire is a horizontal type in which a manufacturing line extends in a horizontal direction.

A conductor 23 having a linear shape is wound around the pulley or bobbin 3. The conductor 23 is drawn out from the pulley or bobbin 3, travels along a path that passes through the round wire drawing machine 5, the flat rolling machine 7, the annealing furnace 9, the flat wire drawing machine 11, the annealing furnace 13, the coating material application machine 15, and the baking furnace 17 in this order, and is wound up by the wind-up machine 19. Note that a flat copper drawn wire 23B to be described below, which is the conductor 23 having been processed, travels through a section including the coating material application machine 15 and the baking furnace 17 multiple times.

A material for the conductor 23 is copper or a copper alloy. A cross-sectional shape of the conductor 23 is circular until a flat rolling to be described below is performed. The cross section of the conductor 23 refers to a section perpendicular to a longitudinal axis of the conductor 23.

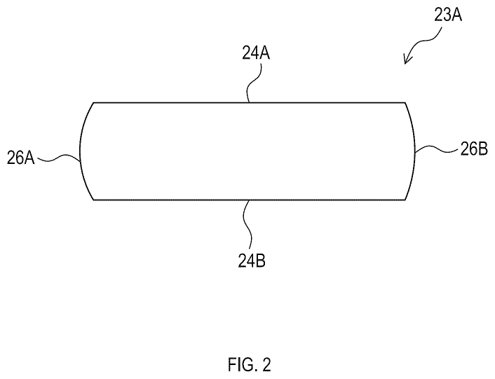

The round wire drawing machine 5 draws the conductor 23 having a circular cross-sectional shape. The flat rolling machine 7 performs the flat rolling on the conductor 23 traveling therethrough. The conductor 23 that has undergone the flat rolling is referred to as a flat copper wire 23A. As shown in FIG. 2, a cross-sectional shape of the flat copper wire 23A is a shape formed by two sides 24A and 24B parallel to each other and two arc-shaped lines 26A and 26B. In the cross section, the shape of the sides 24A and 24B is linear. In the cross section, the length of the sides 24A and 24B is longer than the length of the arc-shaped lines 26A and 26B. The annealing furnace 9 anneals the flat copper wire 23A.

The flat wire drawing machine 11 performs a flat wire drawing on the flat copper wire 23A traveling therethrough. The flat wire drawing is a process of continuously performing cold wire drawing on the flat copper wire 23A using a flat wire drawing die. The conductor 23 that has undergone the flat wire drawing is the flat copper drawn wire 23B.

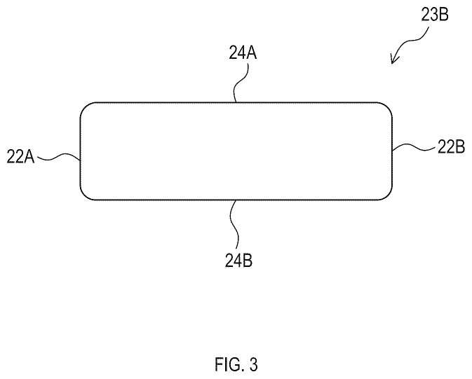

A cross-sectional shape of the flat copper drawn wire 23B is a rounded rectangle as shown in FIG. 3. Longer sides of the rounded rectangle are the sides 24A and 24B. Shorter sides 22A and 22B of the rounded rectangle are sides derived from the arc-shaped lines 26A and 26B, respectively, in the flat copper wire 23A.

As shown in FIG. 1, in the flat wire drawing machine 11 (in the manufacturing apparatus 1), a direction in which the conductor 23 travels is referred to as a traveling direction TR. A direction opposite to the traveling direction TR is referred to as an upstream direction US. The annealing furnace 13 anneals the flat copper drawn wire 23B. The coating material application machine 15 applies an enamel coating material to a surface of the flat copper drawn wire 23B to thereby form a film of the enamel coating material of a given thickness on the surface of the flat copper drawn wire 23B. A wire speed of the flat copper drawn wire 23B when the coating material application machine 15 applies the enamel coating material is preferably 14 m/min or more, and more preferably 20 m/min or more.

The baking furnace 17 applies heat to the flat copper drawn wire 23B traveling therethrough, on which the film of the enamel coating material of the given thickness has been formed by the coating material application machine 15, to bake the coating material film, thus forming an enamel coating. As shown in FIG. 1, the application of the enamel coating material by the coating material application machine 15 and the formation of the enamel coating by the baking furnace 17 are repeatedly performed. For example, the application and baking are repeated 40 times. This results in manufacturing a flat enameled copper wire 25 of a given coating thickness. The flat enameled copper wire 25 is wound up by the wind-up machine 19.

A method for forming an enamel coating is, for example, as follows. The enamel coating material is applied to the surface of the flat copper drawn wire 23B. The enamel coating material is a coating material containing, for example, a resin and a solvent. Next, the solvent in the enamel coating material applied to the surface of the flat copper drawn wire 23B is evaporated, and the resin in the enamel coating material is cured. After the evaporation of the solvent and the cure of the resin, the flat enameled copper wire 25 is formed. The flat enameled copper wire 25 corresponds to an example of an enameled copper wire.

The dehumidifier 20 dehumidifies a space 31 in which the manufacturing apparatus 1 is installed, thereby reducing the absolute humidity in the space 31. The space 31 is a space in which the flat enameled copper wire 25 is manufactured. The dehumidifier 20 sets the absolute humidity in the space 31 to 18 g/m³ or less. For example, a not-shown control section or worker controls the dehumidifier 20 so that the absolute humidity in the space 31 becomes 18 g/m³ or less based on the measured value of the absolute humidity in the space 31. The higher the absolute humidity in the space 31 is, the more enhanced the dehumidifying capability of the dehumidifier 20 is.

### 2. Effects Produced by Manufacturing Apparatus 1 and Manufacturing Method for Flat Enameled Copper Wire

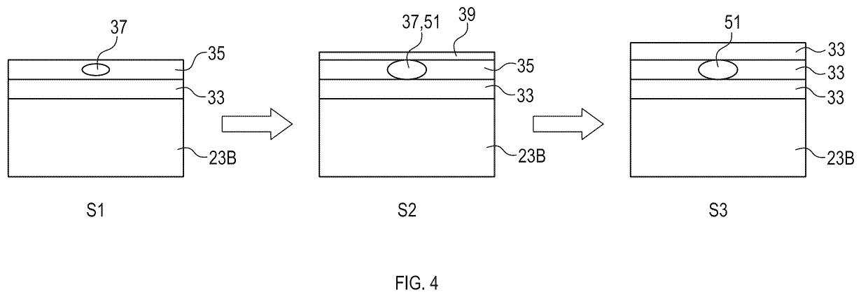

The manufacturing apparatus 1 and the manufacturing method for the flat enameled copper wire can suppress the occurrence of an apparently abnormal part 51 in the flat enameled copper wire 25. The presumed reason is as follows. S1 in FIG. 4 shows a state in which an enamel coating 33 is formed on the flat copper drawn wire 23B and a coating material film 35 is formed thereon. The enamel coating 33 is a film formed by applying and baking the enamel coating material.

The coating material film 35 is a film formed by applying an enamel coating material. The coating material film 35 is a film that contains a large amount of solvent and is not yet cured. While the enamel coating remains in a tank of the coating material application machine 15, the enamel coating material absorbs moisture from the surface thereof. When the absolute humidity increases, a portion 37 having a large amount of moisture locally exists in the coating material film 35.

S2 is a state in which the coating material film 35 is heated after the state of S1. When the absolute humidity in the space is high, a high-viscosity layer 39 is generated on the surface of the coating material film 35. The high-viscosity layer 39 is a portion where the coating material film 35 absorbs moisture from the space 31 and the viscosity increases. The moisture and the solvent contained in the portion 37 having a large amount of moisture cannot be volatilized because the high-viscosity layer 39 exists.

As a result, foaming occurs in the portion 37 having a large amount of moisture, and the apparently abnormal part 51 is generated. In S3, after the state of S2, the coating material film 35 in which the apparently abnormal part 51 has been generated becomes the enamel coating 33, and the enamel coating 33 is further laminated thereon.

In the manufacturing apparatus 1 and the manufacturing method for the flat enameled copper wire, the absolute humidity in the space 31 is 18 g/m³ or less, so that the high-viscosity layer 39 is less likely to be generated. Therefore, moisture contained in the portion 37 having a large amount of moisture is easily volatilized, and foaming is less likely to occur. As a result, the apparently abnormal part 51 is less likely to be generated.

### Example 1

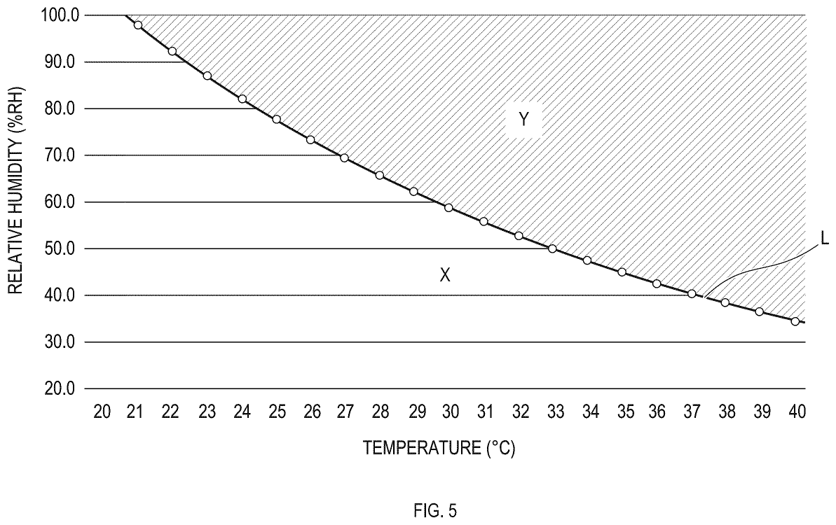

The flat enameled copper wire 25 was manufactured using the manufacturing apparatus 1 while variously changing the temperature and relative humidity in the space 31. The manufacturing conditions were made constant except for the temperature and relative humidity in the space 31. The apparently abnormal part 51 was detected in the manufactured flat enameled copper wire 25. The relationship between the temperature and the relative humidity in the space 31 and probability in generating the apparently abnormal part 51 is shown in FIG. 5.

The horizontal axis in FIG. 5 represents temperature. The vertical axis in FIG. 5 represents relative humidity. On a boundary line L shown in FIG. 5, the absolute humidity in the space 31 is 18 g/m³. A region X shown in FIG. 5 is a region where the absolute humidity in the space 31 is 18 g/m³ or less. A region Y shown in FIG. 5 is a region where the absolute humidity in the space 31 is more than 18 g/m³. In the region X, the apparently abnormal part 51 was less likely to be generated in the flat enameled copper wire 25. In the region Y, the apparently abnormal part 51 was easily generated in the flat enameled copper wire 25. From this result, it was confirmed that when the absolute humidity in the space 31 is 18 g/m³ or less, the apparently abnormal part 51 is less likely to be generated in the flat enameled copper wire 25.

### Example 2

### 1. Manufacture of Flat Enameled Copper Wire 25

The flat enameled copper wire 25 was manufactured using the manufacturing apparatus 1 while variously changing the absolute humidity in the space 31. The manufacturing conditions were made constant except for the absolute humidity in the space 31. The manufacturing conditions were as follows.
Size of Cross Section of Flat Copper Drawn Wire 23B
The lengths of the sides 24A and 24B are 3 mm.
The lengths of the sides 22A and 22B are 2 mm.

### Composition of Enamel Coating Material

A coating material comprises an imide polymer and a solvent.

Examples of the imide polymer include polyimide, polyamic acid, polyamideimide, and polyesterimide. Examples of the solvent include N-methyl-2 pyrrolidone, N, N-dimethylformamide, and N, N-dimethylacetamide, but are not limited thereto. Furthermore, other solvents and additives may be mixed.

The wire speed of the flat copper drawn wire 23B when the coating material application machine 15 applies the enamel coating material: 20 m/min
The applied amount of the enamel coating material in one application: 4 μm
The temperature of baking in the baking furnace 17: 700 to 750° C.
The number of times of applying the enamel coating material: 40
The total thickness of the enamel coating: 160 μm

### 2. Evaluation of Flat Enameled Copper Wire 25

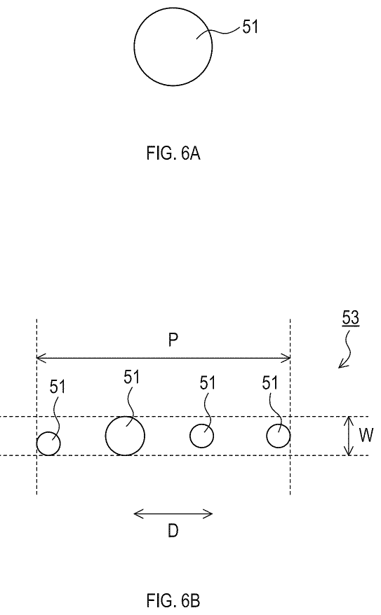

In the manufactured flat enameled copper wire 25, the number of apparently abnormal part 51 was counted. A method of counting the number of the apparently abnormal part 51 was as follows. First, the surface of the flat enameled copper wire 25 was photographed with a camera. In the image by the camera, as shown in FIG. 6A, when one apparently abnormal part 51 exists sufficiently away from another apparently abnormal part 51, it is determined that there is one apparently abnormal part 51. For example, when there is only one apparently abnormal part 51 in the field of view of the image by the camera, it is determined that there is one apparently abnormal part 51.

As shown in FIG. 6B, when the plurality of apparently abnormal parts 51 are arranged along one direction D and both of the following conditions J1 and J2 are satisfied, the plurality of apparently abnormal parts 51 are determined to be one continuous abnormal part 53.
(J1) A width W is 0.5 mm or more.
(J2) An aspect ratio A is 4 or more.

The width W is the total width of the plurality of apparently abnormal parts 51 in the direction orthogonal to the direction D. The aspect ratio A is a value obtained by dividing a length P by the width W. The length P is the total length of the plurality of apparently abnormal parts 51 in the direction D.

When there is one continuous abnormal part 53, it is determined that there are n apparently abnormal parts 51 represented by the following Expression (1).

$$n = f ( P / {P}_{0} ) \qquad Expression ( 1 )$$

In Expression (1), P/P₀ is a value obtained by dividing P by P₀. P₀ is a fixed value, for example, 32 mm. P₀ is, for example, the width of the field of view in an image obtained by photographing the surface of the flat enameled copper wire 25 with a camera.

In Expression (1), f(P/P₀) is the smallest integer larger than P/P₀. For example, when P/P₀ is 0.5, f(P/P₀) is 1. For example, when P/P₀ is 1.5, f(P/P₀) is 2.

On the basis of the number of apparently abnormal parts 51, the manufactured flat enameled copper wires 25 were classified into products inhibiting apparently abnormal parts and products not inhibiting apparently abnormal parts. The product inhibiting apparently abnormal parts is a flat enameled copper wire 25 having less than 30 apparently abnormal parts 51 per 3200 m. The product not inhibiting apparently abnormal parts is a flat enameled copper wire 25 having 30 or more apparently abnormal parts 51 per 3200 m.

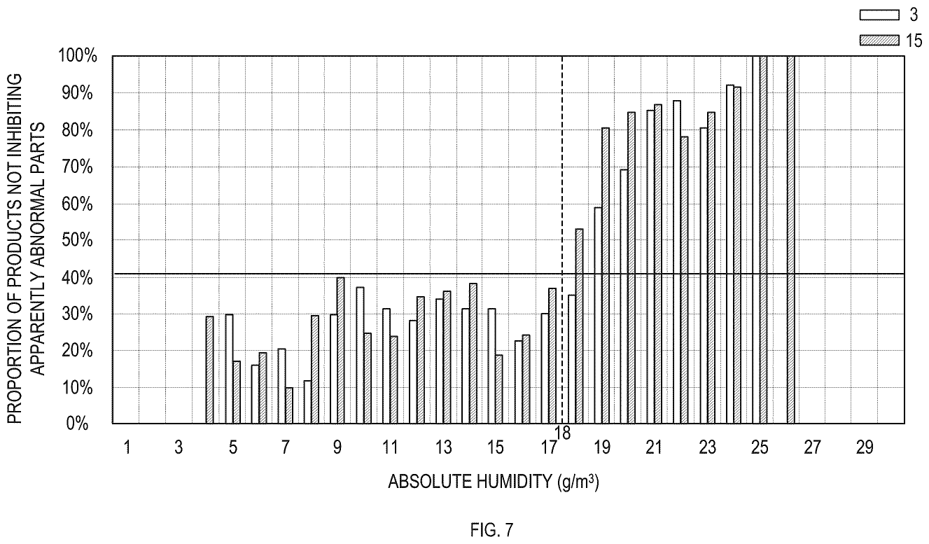

Next, the proportion of products not inhibiting apparently abnormal parts was calculated for each value of the absolute humidity in the space 31. The results are shown in FIG. 7. The horizontal axis in FIG. 7 represents absolute humidity. The vertical axis represents the proportion of products not inhibiting apparently abnormal parts. The absolute humidity in the space 31 was measured at each of the pulley or bobbin 3 and the coating material application machine 15. FIG. 7 shows the absolute humidity at both the locations.

As shown in FIG. 7, when the absolute humidity in the space 31 was 18 g/m³ or less, the proportion of products not inhibiting apparently abnormal parts was remarkably low as compared with the case of exceeding 18 g/m³.

### Other Embodiments

Although the embodiments of the present disclosure have been described so far, the present disclosure is not limited to the above-described embodiments and can be carried out in variously deformed forms.
(1) The manufacturing apparatus 1 for the enameled copper wire may manufacture enameled copper wires other than the flat enameled copper wire and, for example, may manufacture a round-shaped enameled copper wire.
(2) Function/functions of a single element in each embodiment described above may be performed by two or more elements in a shared manner, and function/functions of two or more elements may be performed by a single element. Part of the configuration in each embodiment described above may be omitted. At least a part of the configuration in each embodiment described above may be added to or replace the configuration in another embodiment described above.
(3) In addition to the above-described manufacturing apparatus 1 for the flat enameled copper wire, the present disclosure may be embodied in various forms, such as a system including the manufacturing apparatus 1 for the flat enameled copper wire and a method of controlling absolute humidity.

What is claimed is:

1. A manufacturing apparatus for an enameled copper wire, the manufacturing apparatus comprising:
a coating material application section configured to apply a coating material to a surface of a conductor in traveling;
a baking section configured to bake the conductor to which the coating material has been applied; and
a dehumidifying section configured to set an absolute humidity in a space in which the manufacturing apparatus is installed to 18 g/m³ or less.

2. The manufacturing apparatus for an enameled copper wire according to claim 1,
wherein a wire speed of the conductor when the coating material application section applies the coating material is 14 m/min or more.

3. A manufacturing method for an enameled copper wire, the manufacturing method comprising:
applying a coating material to a surface of a conductor in traveling;
baking the conductor to which the coating material has been applied; and
setting an absolute humidity in a space in which the method for manufacturing an enameled copper wire is performed to 18 g/m³ or less.

4. The manufacturing method for an enameled copper wire according to claim 3,
wherein a wire speed of the conductor when the coating material is applied is 14 m/min or more.
